(19) United States
(12) Patent Application Publication
(10) Pub. No.: US 2026/0219700 A1
(43) Pub. Date: Jul. 30, 2026

(54) DEVICE, SYSTEM AND METHODS FOR A TEMPERATURE COMPENSATED CURRENT REFERENCE

(71) Applicant: Microchip Technology Inc., Chandler, AZ (US)

(72) Inventors: Shubham Mehrotra, Morges (CH); Vincent Quiquempoix, Divonne-Les-Bains (FR); Fabien Vaucher, Lausanne (CH)

(73) Assignee: Microchip Technology Inc., Chandler, AZ (US)

(21) Appl. No.: 19/329,103

(22) Filed: Sep. 15, 2025

Related U.S. Application Data
(60) Provisional application No. 63/750,223, filed on Jan. 27, 2025.

(51) Int. Cl. G05F 3/26

(52) U.S. Cl. CPC G05F 3/26

(57) ABSTRACT

An apparatus may include a current mirror circuit, a cascode circuit, and a current generator circuit. The current generator circuit may produce a Proportional-to-Absolute-Temperature (PTAT) current and a Complementary-to-Absolute-Temperature (CTAT) current. The PTAT current and the CTAT current may be based on a first impedance and a second impedance. A combination of the PTAT current and the CTAT current may serve as a current reference. The values of the first impedance and the second impedance may be chosen to reduce the first-order temperature variation in the current reference. The inversion coefficient of the current generation devices may be modified to reduce the second-order temperature variation in the current reference.

### PRIORITY

This application claims priority to commonly owned United States Provisional Patent Application No. 63/750,223 filed January 27, 2025, the entire contents of which are hereby incorporated by reference for all purposes.

### FIELD OF THE INVENTION

The present disclosure relates to an apparatus, system and method to generate a second-order temperature-compensated current reference.

### BACKGROUND

The current reference circuit is widely used in analog and mixed-signal systems. A current reference may provide a stable bias current for high-precision analog components, including analog-to-digital converters (ADCs), digital-to-analog converters (DACs), amplifiers and precision oscillators.

High-precision analog components may require very stable bias currents over wide operating temperature ranges. Current reference circuits which are susceptible to variation over temperature may impact the performance of those high-precision analog components.

Additionally, low power consumption is a critical performance metric in analog and mixed-signal circuits. Increasing current consumption of the overall solution to improve the operation of a current reference over temperature is not a desirable solution.

There exists a need for current reference circuits which are stable over wide temperature ranges and achieve low overall power consumption.

### SUMMARY

The examples herein enable an apparatus, system and method to generate a second-order temperature-compensated current reference.

According to one aspect, an apparatus includes a current mirror circuit to receive a supply voltage and to output a first current reference and a second current reference. The apparatus includes a cascode circuit to receive as input the first current reference and the second current reference and to output a first cascode output and a second cascode output. The apparatus includes a current generator circuit to receive as input the first cascode output and the second cascode output. A first output of the current generator circuit may be provided to a ground node. A second output of the current generator circuit may be provided to a first impedance. The first impedance may generate a proportional-to-absolute-temperature current and the second cascode output may be provided to a second impedance. The second impedance may generate a complementary-to-absolute-temperature current.

Aspects as in the previous paragraph provide an apparatus, the current mirror circuit comprising a first current mirror device and a second current mirror device, the first current mirror device comprising a first node to receive a supply voltage, a second node communicatively coupled to a second node of the second current mirror device and a third node comprising the first current reference, and the second current mirror device comprising a first node to receive a supply voltage, the second node communicatively coupled to the second node of the first current mirror device and a third node communicatively coupled to the second node of the second current mirror device, the third node comprising the second current reference.

Aspects as in at least one of the two preceding paragraphs provide an apparatus, the cascode circuit comprising a first cascode device and a second cascode device, the first cascode device comprising a first node to receive the first current reference, a second node to receive the first current reference, and a third node comprising the first cascode output, and the second cascode device comprising a first node to receive the second current reference, a second node to receive the first current reference and a third node comprising the second cascode output.

Aspects as in at least one of the three preceding paragraphs provide an apparatus, the current generator circuit comprising a first current generator device and a second current generator device. The first current generator device comprising a first node to receive the first cascode output, a second node to receive the first cascode output and a third node provided to a ground node, and the second current generator device comprising a first node to receive the second cascode output and to provide input to a first node of the second impedance, a second node to receive the first cascode output and a third node to provide input to a first node of the first impedance, wherein a second node of the first impedance is communicatively coupled to a ground node and a second node of the second impedance is communicatively coupled to the ground node.

Aspects as in at least one of the four preceding paragraphs provide an apparatus, wherein the size of the second current generator device is an integer multiple of the size of the first current generator device.

Aspects as in at least one of the five preceding paragraphs provide an apparatus, the size of the first current mirror device substantially equal to the size of the second current mirror device and the absolute value of the first current reference substantially equal to the absolute value of the second current reference.

Aspects as in at least one of the six preceding paragraphs provide an apparatus, wherein the value of the first impedance and the value of second impedance and the inversion coefficient of the first current generator device and the inversion coefficient of the second current generator device are selected to produce a second-order temperature-compensated current reference.

Aspects as in at least one of the seven preceding paragraphs provide an apparatus, wherein the second current reference comprises a linear combination of the current in the first impedance and the current in the second impedance, with current generation devices biased at a specific inversion coefficient to achieve second-order temperature compensation.

Aspects as in at least one of the eight preceding paragraphs provide an apparatus, a startup circuit to provide a current to the first node of the first cascode device to initiate a startup operation.

Aspects as in at least one of the nine preceding paragraphs provide a device, the cascode circuit comprising a series combination of at least one cascode device in a first leg and at least one cascode device in a second leg.

Aspects provide a system, the system comprising an analog peripheral circuit, the analog peripheral circuit to receive a temperature-compensated current reference. The system includes an apparatus to generate the temperature-compensated current reference, the apparatus comprising a current mirror circuit to receive a supply voltage and to output a first current reference and a second current reference. The apparatus comprises a cascode circuit to receive as input the first current reference and the second current reference and to output a first cascode output and a second cascode output. The apparatus comprises a current generator circuit to receive as input the first cascode output and the second cascode output, a first output of the current generator circuit to be provided to a ground node, a second output of the current generator circuit to be provided to a first impedance, the first impedance to generate a proportional-to-absolute-temperature current and the second cascode output to be provided to a second impedance, the second impedance to generate a complementary-to-absolute-temperature current and the current generator circuit to be biased at a specific inversion coefficient to generate a second-order temperature compensation of the first current reference and the second current reference.

Aspects as in the previous paragraph provides a system, wherein the value of the first impedance, the second impedance and the inversion coefficient of the current generator devices may be selected to produce a second-order temperature-compensated current reference, the second-order temperature-compensated current reference to be mirrored to the analog peripheral. The first and second current mirror devices may have the same size, and a first-order temperature-compensated current may be generated at both the first and second current references, which may be mirrored to an analog peripheral.

Aspects as in at least one of the preceding two paragraphs provide a system, wherein the second current reference comprises a linear combination of the current in the first impedance and the current in the second impedance. The second current reference comprises a second-order temperature-compensated current reference wherein the current generation devices are biased at a specific inversion coefficient and the temperature-compensated current reference is mirrored to the analog peripheral.

Aspects as in at least one of the preceding three paragraphs provide a system, the analog peripheral comprising one of an analog-to-digital converter, a digital-to-analog converter, an oscillator, an amplifier, a comparator, a sensor, a switching regulator, and a power management integrated circuit.

Aspects as in at least one of the preceding four paragraphs provide a system, the cascode circuit comprising a series combination of at least one cascode device in a first leg and at least one cascode device in a second leg.

Aspects provide a method, the method comprising steps of: selecting a value for a first impedance; setting a value for a second impedance based on the value of the first impedance and a temperature profile of a current flowing through the first impedance; varying, ratiometrically, the values of the first and second impedances to generate a first-order compensated current reference of a desired value; computing the second-order temperature coefficient of the current reference; and modifying the inversion coefficient of devices in the current generator circuit based on the computed second-order temperature coefficient to generate a second-order temperature-compensated current reference.

Aspects as in the preceding paragraph provide a method, wherein modifying the inversion coefficient of the current generation devices comprises increasing the inversion coefficient if the second-order temperature coefficient of the current reference is less than zero, and decreasing the inversion coefficient if the second-order temperature coefficient of the current reference is greater than zero.

Aspects as in at least one of the two preceding paragraphs provide a method, the value of the first impedance and the value of the second impedance related by a ratio a, the value of a to reduce the first-order temperature dependence of the current reference.

Aspects as in at least one of the three preceding paragraphs provide a method, wherein the inversion coefficient of the current generation devices is to be modified to reduce the second-order temperature dependence of the current reference, based on the second-order temperature coefficient of the current reference.

Aspects as in at least one of the four preceding paragraphs provide a method, the method further comprising repeating the steps of the method to generate a second-order temperature-compensated current reference.

### BRIEF DESCRIPTION OF THE DRAWINGS

FIG. 1 illustrates one of various examples of an apparatus for generating a second-order temperature-compensated current reference.

FIG. 2 illustrates a system for generating a second-order temperature-compensated current reference.

FIG. 3 illustrates one of various examples of a first-order temperature-compensated current reference with a negative second-order temperature coefficient.

FIG. 4 illustrates one of various examples of a first-order temperature-compensated current reference with a positive second-order temperature coefficient.

FIG. 5 illustrates an example of a second-order temperature-compensated current reference.

FIG. 6 illustrates another example of second-order temperature-compensated current reference using a non-ideal resistor (TC1 of R1,2 ≠ 0)

FIG. 7 illustrates a block diagram of a method to generate a second-order temperature-compensated current reference.

### DETAILED DESCRIPTION

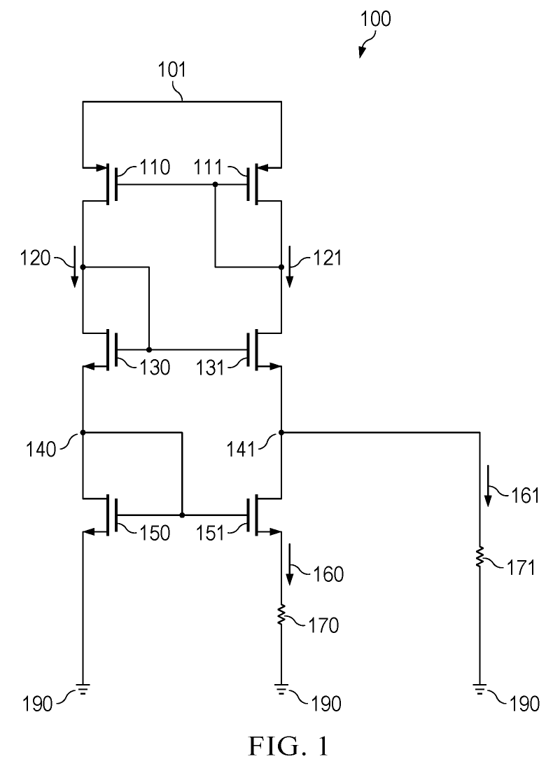

FIG. 1 illustrates one of various examples of an apparatus 100 for generating a second-order temperature-compensated current reference.

Apparatus 100 may include supply 101. Supply 101 may be coupled to a first current mirror device 110 and a second current mirror device 111. First current mirror device 110 and second current mirror device 111 may comprise a current mirror circuit. First current mirror device 110 and second current mirror device 111 may be biased in strong inversion and may have substantially the same size to be well matched in current.

First current mirror device 110 may generate first current reference 120. Second current mirror device 111 may generate second current reference 121. In operation, the current value of first current reference 120 and the current value of the second current reference 121 may, provided the size of first current mirror device 110 is the same as the size of second current mirror device 111, be substantially similar.

A first node of first current mirror device 110 may be coupled to supply 101. A first node of second current mirror device 111 may be coupled to supply 101. Supply 101 may be coupled to a voltage source and may provide a supply voltage to apparatus 100.

A second node of first current mirror device 110 may be coupled to a second node of second current mirror device 111 and to a third node of second current mirror device 111. A third node of first current mirror device 110 may be first current reference 120. The third node of second current mirror device 111 may be second current reference 121.

The third node of first current mirror device 110 may be coupled to a first node of first cascode device 130 and first current reference 120 may be input to first cascode device 130. The third node of second current mirror device 111 may be coupled to a first node of second cascode device 131 and second current reference 121 may be input to second cascode device 131.

A second node of first cascode device 130 may be coupled to a second node of second cascode device 131. The second node of first cascode device 130 may be coupled to the first node of first cascode device 130.

Node 140 may be a first cascode output and may be coupled to a third node of first cascode device 130. Node 141 may be a second cascode output and may be coupled to a third node of second cascode device 131.

First cascode device 130 and second cascode device 131 may comprise a cascode circuit.

A first node of first current generator device 150 may be coupled to node 140. A first node of second current generator device 151 may be coupled to node 141. A second node of first current generator device 150 may be coupled to a second node of second current generator device 151. The second node of first current generator device 150 may be coupled to the first node of first current generator device 150.

In one of various examples, the size of second current generator device 151 may be an integer multiple of the size of first current generator device 150.

A third node of first current generator device 150 may be coupled to ground node 190. A third node of second current generator device 151 may be coupled to a first node of a first impedance 170. A second node of first impedance 170 may be coupled to ground node 190.

The first node of second current generator device 151 may be coupled to a first node of a second impedance 171. The second node of second impedance 171 may be coupled to ground node 190. First current generator device 150 and second current generator device 151 may be initially biased in weak inversion with an inversion coefficient typically less than 0.1.

Current 160 may be a Proportional-to-Absolute-Temperature (PTAT) current, and may be directly proportional to absolute temperature, such that an increase in temperature results in an increase in current. Current 161 may be a Complementary-to-Absolute-Temperature (CTAT) current, and may be inversely proportional to absolute temperature, such that an increase in absolute temperature results in a decrease in current.

In operation, first cascode device 130 and second cascode device 131 may operate in weak inversion. First cascode device 130 and second cascode device 131 may operate in weak inversion to maximize headroom and facilitate operation over a wider supply range. A voltage at node 140 may be substantially equal to a voltage at node 141. Current 160 through first impedance 170 may be a PTAT current, and current 161 through second impedance 171 may be a CTAT current. Second current reference 121 may be a linear combination of current 160 through first impedance 170 and current 161 through second impedance 171. First current reference 120 may be the same as the second current reference 121, and the current mirrors 110 and 111 may have the size ratio 1:1 or have the same size. In one of various examples, a value of first impedance 170 may be R1, and a value of second impedance 171 may be R2. The value of R2 may be set to be R2=α*R1,where α is selected to reduce the variation in the current value of the second current reference 121 across absolute temperature. The value of α may be chosen to produce a second current reference 121 which is first-order compensated for variations in absolute temperature. After finding α, R1 and R2 may be adjusted ratiometrically to achieve the desired value of the current reference. This may be adjusted at one temperature, as the temperature coefficient (TC) may be already compensated for in previous steps. If, after adjustment, the temperature compensation deviates, α may be readjusted. Then, again, the value of first impedance 170 may be varied from R1 and the value of second impedance 171 may be varied from R2 in a ratiometric manner to restore the desired current. The steps may repeat iteratively, until the desired current and desired temperature compensation is achieved.

A second-order temperature coefficient of second current reference 121 may be determined. Based on the second-order temperature coefficient of second current reference 121, the inversion coefficient of first current generator device 150 and second current generator device 151 may be modified. If second current reference 121 has a positive temperature coefficient, the inversion coefficient of first current generator device 150 and second current generator device 151 may be decreased. If second current reference 121 has a negative temperature coefficient, the inversion coefficient of first current generator device 150 and second current generator device 151 may be increased. This process may be repeated iteratively, determining the second-order temperature coefficient and modifying the inversion coefficient to reach a desired second-order temperature coefficient. In this manner, a second-order temperature-compensated current may be generated at second current reference 121.

Second current mirror device 111, second cascode device 131, second current generator device 151, first impedance 170 and second impedance 171 may comprise one leg of apparatus 100. Second current reference 121 may be second-order temperature-compensated based on modifications to the one leg of apparatus 100.

Apparatus 100 is illustrated with complimentary metal-oxide semiconductor (CMOS) devices, but this is not intended to be limiting. Apparatus 100 may include bipolar devices or other transistor types not specifically mentioned. As they are generated as part of a current mirror, first current reference 120 and second current reference 121 may be second-order temperature-compensated.

First cascode device 130 may comprise one portion of a first leg of apparatus 100. Second cascode device 131 may comprise one portion of a second leg of apparatus 100.

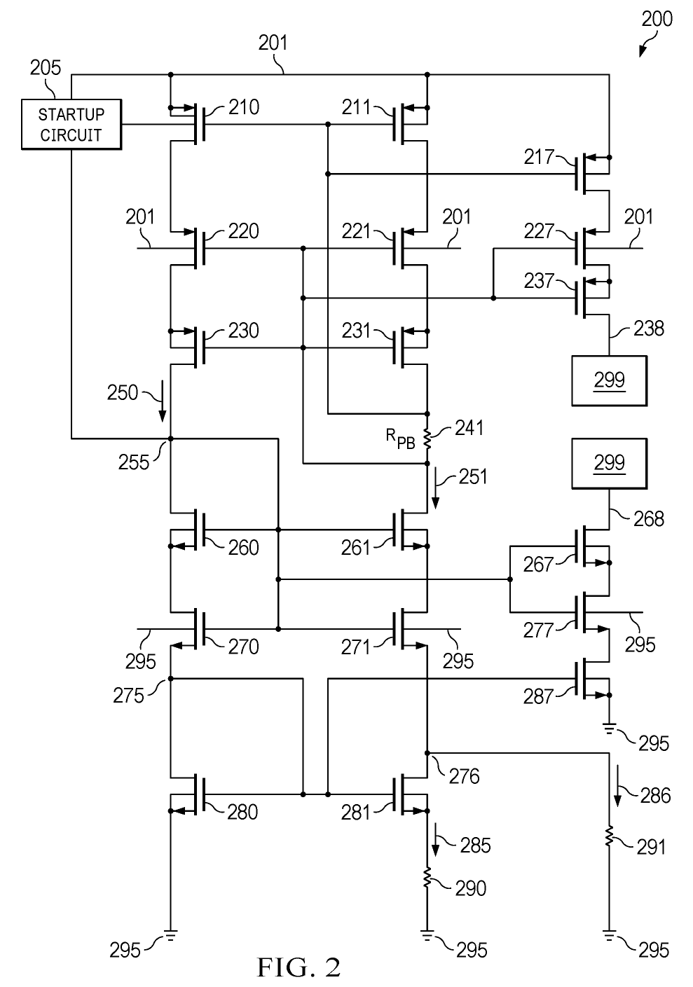

FIG. 2 illustrates a system 200 for generating a second-order temperature-compensated current reference.

System 200 may include supply 201. Supply 201 may be coupled to a first current mirror device 210, to a second current mirror device 211, and to startup circuit 205. A first node of first current mirror device 210 may be coupled to supply 201. A first node of second current mirror device 211 may be coupled to supply 201. Supply 201 may be coupled to a voltage source and may provide a supply voltage to system 200.

First current mirror device 210 and second current mirror device 211 may be biased in strong inversion.

First cascode device 220 and second cascode device 221 may be biased in weak inversion. Third cascode device 230 and fourth cascode device 231 may be biased in weak inversion. Fifth cascode device 260 and sixth cascode device 261 may be biased in weak inversion. Seventh cascode device 270 and eighth cascode device 271 may be biased in weak inversion. First current generator device 280 and second current generator device 281 may be initially biased in weak inversion.

A second node of first current mirror device 210 may be coupled to a second node of second current mirror device 211.

A first node of first cascode device 220 may be coupled to a third node of first current mirror device 210. A first node of second cascode device 221 may be coupled to a third node of second current mirror device 211. A second node of first cascode device 220 may be coupled to a second node of second cascode device 221.

A first node of third cascode device 230 may be coupled to a third node of first cascode device 220. A first node of fourth cascode device 231 may be coupled to a third node of second cascode device 221. A second node of third cascode device 230 may be coupled to a second node of fourth cascode device 231.

A second node of second current mirror device 211 may be coupled to a third node of fourth cascode device 231. A second node of first current mirror device 210 may be coupled to a third node of fourth cascode device 231.

A third node of fourth cascode device 231 may be coupled to a first node of current mirror biasing resistor 241.

A second node of second cascode device 221 may be coupled to a second node of current mirror biasing resistor 241. A second node of first cascode device 220 may be coupled to a second node of current mirror biasing resistor 241.

A second node of fourth cascode device 231 may be coupled to a second node of current mirror biasing resistor 241. A second node of third cascode device 230 may be coupled to a second node of current mirror biasing resistor 241.

First current mirror device 210, second current mirror device 211, first cascode device 220, second cascode device 221, third cascode device 230, fourth cascode device 231 and current mirror biasing resistor 241 may comprise a current mirror circuit.

The value of current mirror biasing resistor 241 depends on the current flowing through current mirror biasing resistor 241. First cascode device 220 and second cascode device 221 may themselves function as a cascode, but to further increase the output impedance, third cascode device 230 and fourth cascode device 231 may be added. The bulk connection of first cascode device 220 and the bulk connection of second cascode device 221 may be connected to supply 201. The bulk connection of third cascode device 230 may be connected to the source node of third cascode device 230 and the bulk connection of fourth cascode device 231 may be connected to the source node of fourth cascode device 231. This approach of partitioning the cascode devices may increase the output impedance and preserve headroom.

One node of third cascode device 230 may be coupled to first current reference 250 and one node of fourth cascode device 231 may be coupled to second current reference 251. In operation, the current value of first current reference 250 and the current value of the second current reference 251 may be substantially similar, provided the size of first current mirror device 210 is the same as second current mirror device 211.

Startup circuit 205 may produce a current at node 255, the current from the startup circuit 205 to provide current at node 255 to initiate a startup operation of system 200.

The third node of third cascode device 230 may be coupled to a first node of fifth cascode device 260 and first current reference 250 may be input to fifth cascode device 260. The second node of current mirror biasing resistor 241 may be coupled to a first node of sixth cascode device 261 and second current reference 251 may be input to sixth cascode device 261 via current mirror biasing resistor 241.

A second node of fifth cascode device 260 may be coupled to a second node of sixth cascode device 261. The second node of fifth cascode device 260 may be coupled to the first node of fifth cascode device 260 and may be coupled to an output of startup circuit 205.

A third node of fifth cascode device 260 may be coupled to a first node of seventh cascode device 270. A third node of sixth cascode device 261 may be coupled to a first node of eighth cascode device 271.

A second node of seventh cascode device 270 may be coupled to a second node of eighth cascode device 271. The second node of seventh cascode device 270 may be coupled to the first node of fifth cascode device 260 and may be coupled to an output of startup circuit 205.

Fifth cascode device 260, sixth cascode device 261, seventh cascode device 270 and eighth cascode device 271 may comprise a cascode circuit. Seventh cascode device 270 and eighth cascode device 271 may themselves function as a cascode. To further increase the output impedance, fifth cascode device 260 and sixth cascode device 261 may be added. The bulk connection of fifth cascode device 260 may be coupled to the source node of fifth cascode device 260. The bulk connection of sixth cascode device 261 may be connected to the source node of sixth cascode device 261. The bulk connection of seventh cascode device 270 and the bulk connection of eighth cascode device 271 may be coupled to ground node 295. Fifth cascode device 260 and sixth cascode device 261 may be deep N-well devices. This approach of partitioning the cascode devices may increase the output impedance and preserve headroom.

Node 275 may be a first cascode output and may be coupled to a third node of seventh cascode device 270. Node 276 may be a second cascode output and may be coupled to a third node of eighth cascode device 271.

Node 275 may be coupled to first current generator device 280. Node 276 may be coupled to second current generator device 281. First current generator device 280 and second current generator device 281 may be low-voltage devices which may enable wider supply operation with better matching of threshold voltages.

A first node of first current generator device 280 may be coupled to node 275. A first node of second current generator device 281 may be coupled to node 276. A second node of first current generator device 280 may be coupled to a second node of second current generator device 281. The second node of first current generator device 280 may be coupled to the first node of first current generator device 280.

The third node of first current generator device 280 may be coupled to ground node 295. The third node of second current generator device 281 may be coupled to a first node of a first impedance 290. A second node of first impedance 290 may be coupled to ground node 295.

The first node of second current generator device 281 may be coupled to a first node of a second impedance 291. The second node of second impedance 291 may be coupled to ground node 295.

First current generator device 280 and second current generator device 281 may be initially biased in weak inversion, with an inversion coefficient below 0.1, and current 285 may be a Proportional-to-Absolute-Temperature (PTAT) current, and may be directly proportional to absolute temperature, such that an increase in temperature results in an increase in current. Current 286 may be a Complementary-to-Absolute-Temperature (CTAT) current, and may be inversely proportional to absolute temperature, such that an increase in absolute temperature results in a decrease in current.

The voltage at node 275 may be substantially equal to the voltage at node 276. Current 285 through first impedance 290 may be a PTAT current, and current 286 through second impedance 291 may be a CTAT current. Second current reference 251 may be a linear combination of current 285 through first impedance 290 and current 286 through second impedance 291. In one of various examples, a value of the first impedance may be R1, and a value of the second impedance may be R2. The value of R2 may be set to be R2=α*R1, where α is selected to reduce the variation in the second current reference across absolute temperature. The value of α may be chosen to produce a second current reference 251 which is first-order compensated for variations in absolute temperature. After finding α, R1 and R2 may be adjusted ratiometrically to achieve the desired value of the current reference. This may be performed at one temperature, as the temperature coefficient (TC) is already compensated for in previous steps. If, after adjustment, the temperature compensation changes, α may be readjusted. Then, the value of R1 and R2 may be varied ratiometrically to restore the desired current. The steps may be repeated iteratively until the desired current with the desired temperature compensation is achieved.

A second-order temperature coefficient of the second current reference 251 may be determined. Based on the second-order temperature coefficient of the second current reference 251, the inversion coefficients of the first current generator device 280 and the second current generator device 281 may be modified. If the second current reference 251 has a positive temperature coefficient, the inversion coefficients of the first current generator device 280 and the second current generator device 281 may be decreased. If the second current reference 251 has a negative temperature coefficient, the inversion coefficients of the first current generator device 280 and the second current generator device 281 may be increased. This process may be repeated iteratively, determining the second-order temperature coefficient and modifying the inversion coefficients to achieve a desired second-order temperature coefficient. In this manner, a second-order temperature-compensated current may be generated at the second current reference 251.

A bulk connection of first cascode device 220 may be coupled to supply 201. A bulk connection of second cascode device 221 may be coupled to supply 201. A bulk connection of seventh cascode device 270 may be coupled to a ground node.

A bulk connection of eighth cascode device 271 may be coupled to a ground node. The cascodes may be partitioned by connecting the bulk connection of fifth cascode device 260 to the source node of fifth cascode device 260 and by connecting the bulk connection of sixth cascode device 261 to the source node of sixth cascode device 261. Fifth cascode device 260 and sixth cascode device 261 may be deep n-well devices. A bulk connection of third cascode device 230 may be coupled to the source node of third cascode device 230 rather than to a supply node. The bulk connection of fourth cascode device 231 may be coupled to the source node of fourth cascode device 231 rather than to a supply node. This approach of partitioning the cascode devices may increase the output impedance and preserve headroom. This approach may achieve high PSRR together with temperature compensation at very low power.

System 200 is illustrated with complimentary metal-oxide semiconductor (CMOS) devices, but this is not intended to be limiting. System 200 may include bipolar devices or other transistor types not specifically mentioned.

Second current generator device 281, first impedance 290 and second impedance 291 may comprise one portion of a single leg of system 200.

In one of various examples, the size of second current generator device 281 may be an integer multiple of the size of first current generator device 280. The sizes of first current mirror device 210 and second current mirror device 211 may be substantially the same size.

In one of various examples, the sizes of first current mirror device 210 and second current mirror device 211 may be related by an integer multiple, and the size of second current generator device 281 and the size of first current generator device 280 may be substantially equal.

Devices 217, 227 and 237 may comprise a current mirror and may source reference current 238 to analog peripheral 299. A bulk connection of device 227 may be coupled to supply 201. Devices 267,277 and 287 may comprise a current mirror and may sink reference current 268 from analog peripheral 299. A bulk connection of device 277 may be coupled to ground node 295.

Analog peripheral 299 may be an analog-to-digital converter (ADC), digital-to-analog converters (DAC), amplifier, precision oscillator, or another analog circuit not specifically mentioned.

As they are generated as part of a current mirror, first current reference 250 and second current reference 251 may both be second-order temperature-compensated.

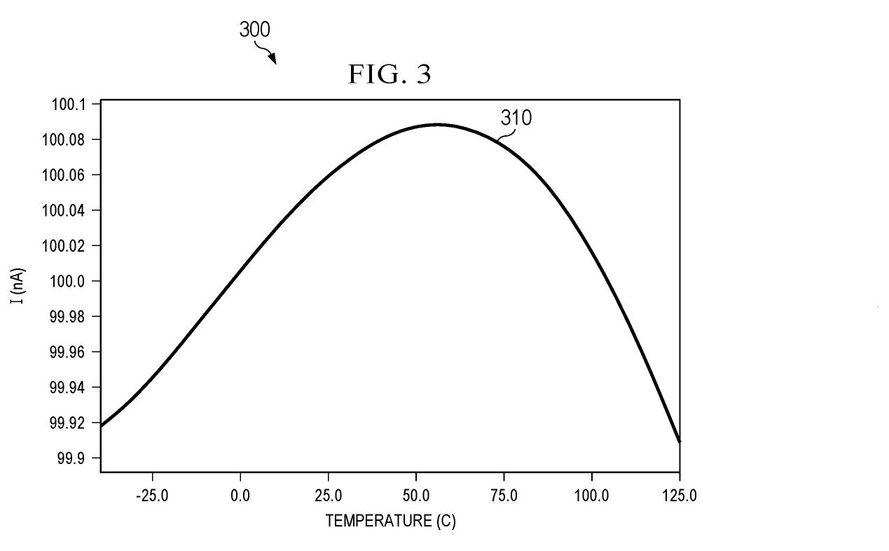

FIG. 3 illustrates one of various examples of a first-order temperature-compensated current reference with a negative second-order temperature coefficient.

Trace 310 may represent one of various examples of second current reference 121 as described and illustrated in reference to FIG. 1. Trace 310 may represent one of various examples of second current reference 251 as described and illustrated in reference to FIG. 2.

Trace 310 may represent a current generated by a first current generator device 150 and a second current generator device 151 biased in weak inversion, as described and illustrated in reference to FIG. 1.

The specific temperature ranges, current values, and temperature variation illustrated in FIG. 3 is not intended to be limiting. In other examples, a different temperature range may be represented, a different current value may be represented, and a different temperature variation may be represented.

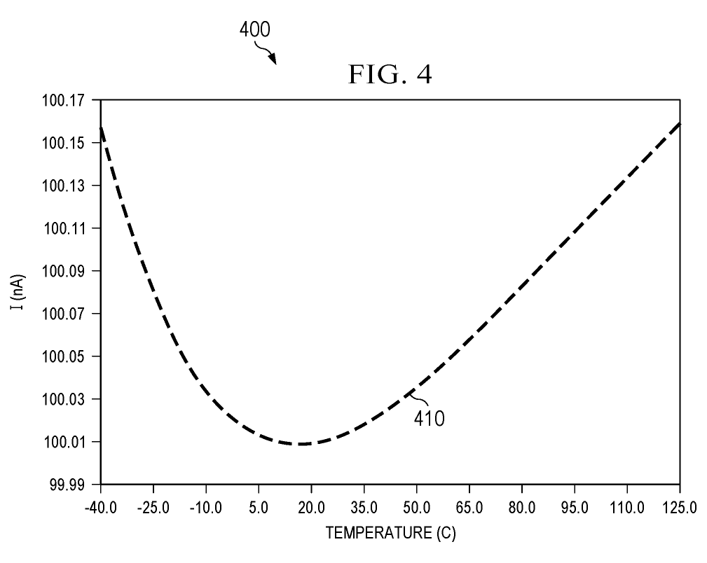

FIG. 4 illustrates one of various examples of a first-order temperature-compensated current reference with a positive second-order temperature coefficient.

Trace 410 may represent one of various examples of second current reference 121 as described and illustrated in reference to FIG. 1. Trace 410 may represent one of various examples of second current reference 251 as described and illustrated in reference to FIG. 2.

Trace 410 may represent a current generated by a first current generator device 150 and a second current generator device 151 biased towards strong inversion, as described and illustrated in reference to FIG. 1.

The specific temperature ranges, current values, and temperature variation illustrated in FIG. 4 is not intended to be limiting. In other examples, a different temperature range may be represented, a different current value may be represented, and a different temperature variation may be represented.

As illustrated in FIG. 3 and FIG. 4, by varying the inversion coefficient, the temperature coefficient of a current reference may be modified. A negative temperature coefficient, as illustrated by trace 310, may be compensated by increasing the inversion coefficient to a more strong inversion operating point. A positive temperature coefficient, as illustrated by trace 410, may be compensated by decreasing the inversion coefficient to a more weak inversion operating point.

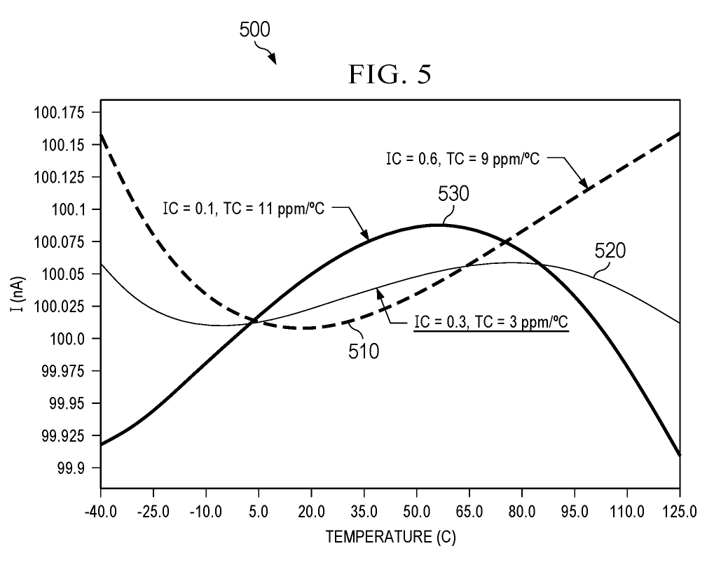

FIG. 5 illustrates an example of a second-order temperature-compensated current reference.

Trace 510 may represent one of various examples of second current reference 121 as described and illustrated in reference to FIG. 1. Trace 510 may represent one of various examples of second current reference 251 as described and illustrated in reference to FIG. 2. Trace 510 may be generated by biasing current generation devices at an inversion coefficient of 0.6, and may generate a current reference with a temperature coefficient of 9 ppm/deg C. In one of various examples, the current generation devices may comprise at least one of first current generator device 280 and second current generator device 281 as described and illustrated in reference to FIG. 2.

Trace 520 may represent one of various examples of second current reference 121 as described and illustrated in reference to FIG. 1. Trace 520 may represent one of various examples of second current reference 251 as described and illustrated in reference to FIG. 2. Trace 520 may be generated by biasing current generation devices at an inversion coefficient of 0.3, and may generate a current reference with a temperature coefficient of 3 ppm/deg C. In one of various examples, the current generation devices may comprise at least one of first current generator device 280 and second current generator device 281 as described and illustrated in reference to FIG. 2.

Trace 530 may represent one of various examples of second current reference 121 as described and illustrated in reference to FIG. 1. Trace 530 may represent one of various examples of second current reference 251 as described and illustrated in reference to FIG. 2. Trace 530 may be generated by biasing current generation devices at an inversion coefficient of 0.1, and may generate a current reference with a temperature coefficient of 11 ppm/deg C. In one of various examples, the current generation devices may comprise at least one of first current generator device 280 and second current generator device 281 as described and illustrated in reference to FIG. 2.

As illustrated in FIG. 5, the inversion coefficient of the current generation devices may be varied to generate different temperature coefficients in a current reference. The specific temperature ranges, current values, inversion coefficients and temperature variation illustrated in FIG. 5 is not intended to be limiting. In other examples, a different temperature range may be represented, a different current value may be represented, a different inversion coefficient may be represented, and a different temperature variation may be represented.

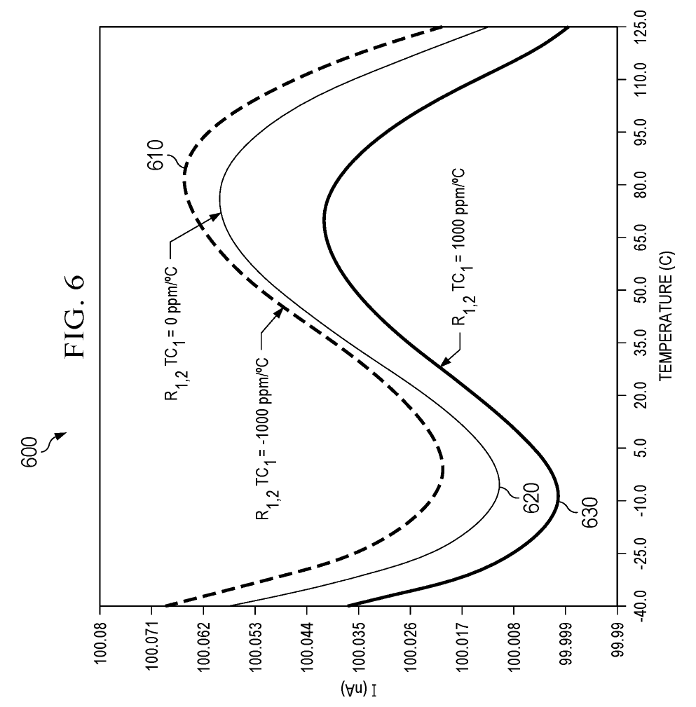

FIG. 6 illustrates another example of second-order temperature-compensated current reference using a non-ideal resistor (TC1 of R1,2 ≠ 0).

Trace 610 may represent one of various examples of second current reference 121 as described and illustrated in reference to FIG. 1. Trace 610 may be generated based on a first impedance 170 and a second impedance 171 with a large negative temperature coefficient.

Trace 610 may represent one of various examples of second current reference 251 as described and illustrated in reference to FIG. 2. Trace 610 may be generated based on a first impedance 170 and a second impedance 171 with a large negative temperature coefficient.

Trace 610 illustrates that impedances with large negative temperature coefficients may be effectively compensated.

Trace 620 may represent one of various examples of second current reference 121 as described and illustrated in reference to FIG. 1. Trace 620 may be generated based on a first impedance 170 and a second impedance 171 with a zero temperature coefficient.

Trace 620 may represent one of various examples of second current reference 251 as described and illustrated in reference to FIG. 2. Trace 620 may be generated based on a first impedance 170 and a second impedance 171 with a zero temperature coefficient.

Trace 620 illustrates that impedances with zero temperature coefficients may be effectively compensated.

Trace 630 may represent one of various examples of second current reference 121 as described and illustrated in reference to FIG. 1. Trace 630 may be generated based on a first impedance 170 and a second impedance 171 with a large positive temperature coefficient.

Trace 630 may represent one of various examples of second current reference 251 as described and illustrated in reference to FIG. 2. Trace 630 may be generated based on a first impedance 170 and a second impedance 171 with a large positive temperature coefficient.

Trace 630 illustrates that impedances with large positive temperature coefficients may be effectively compensated.

As illustrated in FIG. 6, a wide range of impedance temperature coefficients may be compensated. The specific temperature ranges, current values, temperature coefficients and temperature variation illustrated in FIG. 6 is not intended to be limiting. In other examples, a different temperature range may be represented, a different current value may be represented, a different temperature coefficient may be represented, and a different temperature variation may be represented.

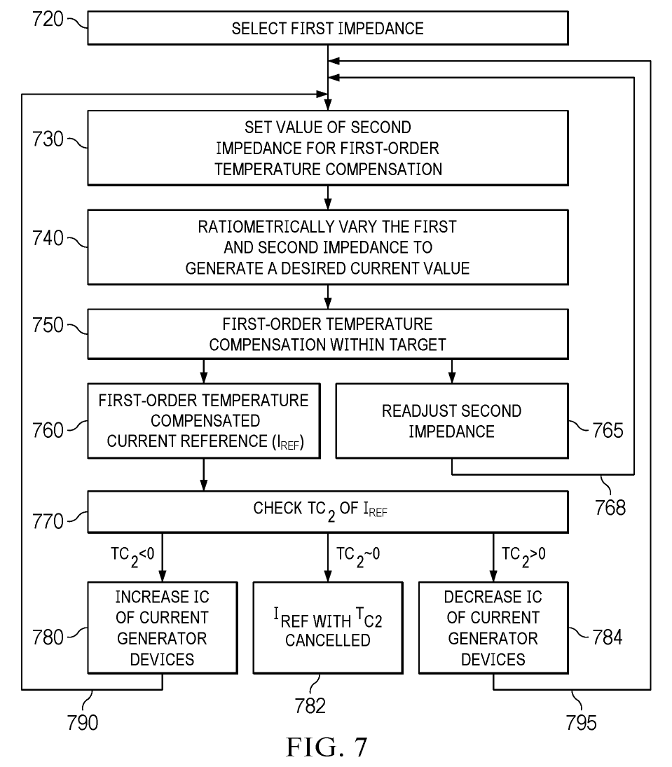

FIG. 7 illustrates a block diagram of a method to generate a second-order temperature-compensated current reference.

The method illustrated in FIG. 7 may be a method used to generate a temperature-compensated current reference in a device as described and illustrated in reference to FIG. 1 or FIG. 2.

At operation 720, a value of a first impedance may be selected. The first impedance may be first impedance 170 as described and illustrated in reference to FIG. 1. The first impedance may be first impedance 290 as described and illustrated in reference to FIG. 2. The value of the first impedance may be selected based on a noise requirement, a voltage requirement, a headroom requirement or another circuit requirement not specifically mentioned.

At operation 730, a value of a second impedance may be determined to produce a first-order temperature-compensated current reference. The second impedance may be second impedance 171 as described and illustrated in reference to FIG. 1. The second impedance may be second impedance 291 as described and illustrated in reference to FIG. 2.

In one of various examples, the second impedance may be determined based on the temperature profile of a current flowing through the first impedance, and may be based on the equation R2 = α *R1, where R2 is a value of the second impedance, R1 is a value of the first impedance, and α is a scalar value. A value of α may be selected to reduce the first-order temperature coefficient of the current reference. The current reference may be second current reference 121 as described and illustrated in reference to FIG. 1. The current reference may be the second current reference 251 as described and illustrated in reference to FIG. 2.

At operation 740, the values of the first impedance and the second impedance may be varied ratiometrically, without changing the value of *** ERROR: No Symbol mapping for puaHex=61. Looks like α may have been intended. ***, to produce a desired current value at the current reference.

At operation 750, a first-order temperature coefficient of the current reference may be determined, and may be compared against a target value. The first-order temperature coefficient may be determined based on a circuit simulation or based on measurement of circuit performance. The current reference may be the second current reference 121 as described and illustrated in reference to FIG. 1. The current reference may be the second current reference 251 as described and illustrated in reference to FIG. 2.

If the first-order temperature coefficient is outside the target value, the method may proceed to operation 765 and the value of the second impedance may be adjusted, and the method may proceed to operation 730 and repeat the operations to ratiometrically vary the first and second impedances and may re-evaluate the first-order temperature coefficient.

If the first-order temperature coefficient is within the target value, the method may proceed to operation 760 based on the current reference comprising a first-order temperature-compensated current reference. The first-order temperature compensated current reference may be referred to as I_{REF}.

At operation 770, a second-order temperature coefficient of the current reference I_{REF} may be determined. The second-order temperature coefficient may be termed TC2.

At operation 780, if the second-order temperature coefficient is less than zero, the inversion coefficient of the current generator devices may be increased. As one of various examples, if the second-order temperature coefficient calculated at operation 770 is a negative value, the inversion coefficient of first current generator device 280 and the second current generator device 281, as described and illustrated in reference to FIG. 2, may be increased. The method may return to operation 730 and repeat steps 730 and following.

At operation 784, if the second-order temperature coefficient is greater than zero, the inversion coefficient of the current generator devices may be decreased. As one of various examples, if the second-order temperature coefficient calculated at operation 770 is a positive value, the inversion coefficient of first current generator device 280 and the second current generator device 281, as described and illustrated in reference to FIG. 2, may be decreased. The method may return to operation 730 and repeat steps 730 and following.

At operation 782, if the second-order temperature coefficient is substantially equal to zero, the method is completed and the second-order temperature-compensated current reference I_{REF} may be output to other circuits in the system.

1. An apparatus comprising:
a current mirror circuit to receive a supply voltage and to output a first current reference and a second current reference;
a cascode circuit to receive as input the first current reference and the second current reference and to output a first cascode output and a second cascode output; and
a current generator circuit to receive as input the first cascode output and the second cascode output, a first output of the current generator circuit to be provided to a ground node, a second output of the current generator circuit to be provided to a first impedance, the first impedance to generate a proportional-to-absolute-temperature current and the second cascode output to be provided to a second impedance, the second impedance to generate a complementary-to-absolute-temperature current.

2. The apparatus as claimed in claim 1, the current mirror circuit comprising a first current mirror device and a second current mirror device, the first current mirror device comprising a first node to receive a supply voltage, a second node communicatively coupled to a second node of the second current mirror device and a third node comprising the first current reference, and the second current mirror device comprising a first node to receive a supply voltage, the second node communicatively coupled to the second node of the first current mirror device and a third node communicatively coupled to the second node of the second current mirror device, the third node comprising the second current reference.

3. The apparatus as claimed in claim 1, the cascode circuit comprising a first cascode device and a second cascode device, the first cascode device comprising a first node to receive the first current reference, a second node to receive the first current reference, and a third node comprising the first cascode output, and the second cascode device comprising a first node to receive the second current reference, a second node to receive the first current reference and a third node comprising the second cascode output.

4. The apparatus as claimed in claim 1, the current generator circuit comprising a first current generator device and a second current generator device, the first current generator device comprising a first node to receive the first cascode output, a second node to receive the first cascode output and a third node provided to a ground node, and the second current generator device comprising a first node to receive the second cascode output and to provide input to a first node of the second impedance, a second node to receive the first cascode output and a third node to provide input to a first node of the first impedance, wherein a second node of the first impedance is communicatively coupled to a ground node and a second node of the second impedance is communicatively coupled to the ground node.

5. The apparatus as claimed in claim 4, wherein the size of the second current generator device is an integer multiple of the size of the first current generator device.

6. The apparatus as claimed in claim 2, the size of the first current mirror device substantially equal to the size of the second current mirror device and the absolute value of the first current reference substantially equal to the absolute value of the second current reference.

7. The apparatus as claimed in claim 4, wherein the value of the first impedance and the value of second impedance and the inversion coefficient of the first current generator device and the inversion coefficient of the second current generator device are selected to produce a second-order temperature-compensated current reference.

8. The apparatus as claimed in claim 1, wherein the second current reference comprises a linear combination of the current in the first impedance and the current in the second impedance, the second current reference comprising a temperature-compensated current reference based on the current generation devices biased at a specific inversion coefficient.

9. The apparatus as claimed in claim 3, a startup circuit to provide a current to the first node of the first cascode device to initiate a startup operation.

10. The apparatus as claimed in claim 1, the cascode circuit comprising a series combination of at least one cascode device in a first leg and at least one cascode device in a second leg.

11. A system comprising:
an analog peripheral circuit, the analog peripheral circuit to receive a temperature-compensated current reference;
an apparatus to generate the temperature-compensated current reference, the apparatus comprising:
a current mirror circuit to receive a supply voltage and to output a first current reference and a second current reference;
a cascode circuit to receive as input the first current reference and the second current reference and to output a first cascode output and a second cascode output; and
a current generator circuit to receive as input the first cascode output and the second cascode output, a first output of the current generator circuit to be provided to a ground node, a second output of the current generator circuit to be provided to a first impedance, the first impedance to generate a proportional-to-absolute-temperature current and the second cascode output to be provided to a second impedance, the second impedance to generate a complementary-to-absolute-temperature current, the current generator circuit to be biased at a specific inversion coefficient to generate a second-order temperature compensation of the first current reference and the second current reference.

12. The system as claimed in claim 11, wherein the value of the first impedance, the second impedance and the inversion coefficient of the current generator devices selected to produce a second-order temperature-compensated current reference, the second-order temperature-compensated current reference to be mirrored to the analog peripheral.

13. The system as claimed in claim 12, wherein the second current reference comprises a linear combination of the current in the first impedance and the current in the second impedance, the second current reference comprising a temperature-compensated current reference wherein the current generation devices are biased at a specific inversion coefficient and the temperature-compensated current reference to be mirrored to the analog peripheral.

14. The system as claimed in claim 13, the analog peripheral comprising one of an analog-to-digital converter, a digital-to-analog converter, an oscillator, an amplifier, a comparator, a sensor, a switching regulator, and a power management integrated circuit.

15. The system as claimed in claim 13, the cascode circuit comprising a series combination of at least one cascode device in a first leg and at least one cascode device in a second leg.

16. A method comprising:
selecting a value of a first impedance,
setting a value of a second impedance based on the value of the first impedance and a temperature profile of a current flowing through the first impedance;
varying, ratiometrically, the values of the first impedance and the second impedance to generate a desired current value and to generate a current reference,
comparing a first-order temperature coefficient of the current reference with a target value,
readjusting the value of the second impedance based on the first-order temperature coefficient being outside the target value,
computing a second-order temperature coefficient based on the first-order temperature coefficient being within the target value,
and modifying the inversion coefficient of a device in a current generator circuit based on the second-order temperature coefficient, to generate a second-order temperature-compensated current reference.

17. The method as claimed in claim 16, modifying the inversion coefficient comprising increasing the inversion coefficient if the second-order temperature coefficient is less than zero, and decreasing the inversion coefficient if the second-order temperature coefficient is greater than zero.

18. The method as claimed in claim 16, the value of the first impedance and the value of the second impedance related by a ratio a, the value of a to reduce the first-order temperature dependence of the temperature-compensated current reference.

19. The method as claimed in claim 16, inversion coefficient to be modified to reduce the second-order temperature dependence of the temperature-compensated current reference based on the combination of the current flowing through the first impedance and the current flowing through the second impedance.

20. The method as claimed in claim 16, the method further comprising repeating the steps of the method to generate a second-order temperature-compensated current reference.
